(19) United States
(12) Patent Application Publication
(10) Pub. No.: US 2009/0303279 A1
(43) Pub. Date: Dec. 10, 2009

(54) NOZZLE WETTING APPARATUS AND INKJET IMAGE FORMING APPARATUS HAVING THE SAME

(75) Inventor: Hee-yuel ROH, Suwon-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/323,608

(22) Filed: Nov. 26, 2008

(30) Foreign Application Priority Data
Jun. 10, 2008 (KR) 2008-54310

(51) Int. Cl. B41J 2/175

(52) U.S. Cl. 347/28

(57) ABSTRACT

A nozzle wetting apparatus for an inkjet image forming apparatus includes a cleaning solution tank to store cleaning solution for cleaning a nozzle; a cleaning solution supplying unit to supply cleaning solution to the nozzle, the cleaning solution supplying unit including a vibration generating member to generate vibrations to atomize the cleaning solution. The nozzle wetting apparatus applies cleaning solution to the nozzles to clean the nozzles of the image forming apparatus without touching the nozzles.

### CROSS-REFERENCE TO RELATED APPLICATIONS

This application claims the benefit under 35 U.S.C. §119(a) from Korean Patent Application No. 2008-54310 filed Jun. 10, 2008 in the Korean Intellectual Property Office, the disclosure of which is incorporated herein by reference.

### BACKGROUND OF THE INVENTION

1. Field of the Invention

Aspects of the present invention relate to an image forming apparatus. More particularly, aspects of the present invention relate to a nozzle wetting apparatus usable with an array type image forming apparatus having a plurality of inkjet heads and an inkjet image forming apparatus having the same.

2. Description of the Related Art

Inkjet image forming apparatuses may include a shuttle type, having a carrier formed to reciprocate, and an array type, having a plurality of inkjet heads arranged to correspond to the width of a printing medium. The shuttle type inkjet image forming apparatus is cheap and has a simple structure. The array type inkjet image forming apparatus is more expensive than the shuttle type image forming apparatus but can print at a high speed and in a high resolution. Therefore, the array type inkjet image forming apparatus may be used as industrial image forming apparatuses or high-end image forming apparatuses.

However, in inkjet image forming apparatus having nozzles that fire ink regardless of the shuttle type and the array type, ink that has not been moved to the printing medium during a printing operation may remain on the nozzle of the inkjet head after the printing operation. Therefore, if the inkjet image forming apparatus has not been used for a long time, the remaining ink may be solidified and clog the nozzle so that the printing operation cannot be performed normally. In other words, when the inkjet image forming apparatus has not been used for a time, the remaining ink may be solidified on a nozzle surface. Also, the remaining ink may be solidified with contaminants, such as dust, entering from the outside to clog the nozzle. A phenomenon in that the nozzle is clogged with the solidified ink and/or contaminants is referred to as ‘nozzle clog’. The nozzle clog deteriorates printing quality.

When the nozzle clog occurs, ink is solidified on the nozzle surface of the inkjet head. Therefore, even when the nozzle surface is cleaned using a dry wiping apparatus, such as a cleaning wiper unit formed to contact and clean the nozzle before or after the printing operation, it is difficult to sufficiently clean the nozzle surface.

To solve this problem, there has recently been proposed nozzle wetting apparatuses that provide a quantity of cleaning solution to the nozzle surface on which ink is solidified, dissolve the solidified ink, and wipe out the nozzle surface. An example of the conventional nozzle wetting apparatus is illustrated in FIG. 1.

FIG. 1 illustrates an example of the conventional contact type nozzle wetting apparatus that contacts the nozzle on which a nozzle clog occurs and supplies it with a quantity of cleaning solution. The contact type nozzle wetting apparatus includes a shuttle carrier 10 disposed to move and face the nozzle 1, a roller 11 rotatably disposed on the shuttle carrier 10, and a blade 12 that contacts the nozzle 1 wetted by the roller 11 and removes the ink and contaminants dissolved by the cleaning solution.

Because the roller 11 contains a quantity of cleaning solution, when the roller 11 rotates in contact with the nozzle 1 of the inkjet head, the cleaning solution contained in the roller 11 dissolves ink and/or contaminants solidified on the surface of the nozzle 1, and then, the dissolved ink and/or contaminants are removed by the roller 11 and the blade 12.

However, in the contact type nozzle wetting apparatus, the roller 11 may cause a secondary contamination to occur at the nozzle 1. In other words, because the roller 11 is clean in the early period of using the roller 11, the roller 11 can clean the nozzle 1 clearly. While the roller 11 has been used over a predetermined period, the ink and contaminants being dissolved by the cleaning solution move into and contaminate the roller 11. Therefore, if the roller 11 is not replaced by a new roller after the predetermined period, the contaminated roller 11 causes the nozzle 1 to be secondly contaminated during the cleaning process so that color mixing may occur in the nozzle 1. Therefore, it is required to develop a nozzle wetting apparatus that removes the nozzle clog and does not contact the nozzle 1.

### SUMMARY OF THE INVENTION

Aspects of the present invention provide solutions to overcome the above drawbacks and/or other problems associated with the conventional arrangement. An aspect of the present invention provides a nozzle wetting apparatus is usable with an inkjet image forming apparatus to easily remove a nozzle clog and is configured to prevent a removing operation of the nozzle clogging from causing a secondary contamination to occur in a nozzle, and an inkjet image forming apparatus having the same.

Aspects of the present invention provide a nozzle wetting apparatus usable with an inkjet image forming apparatus, the nozzle wetting apparatus including a cleaning solution tank to store cleaning solution for cleaning a nozzle; and a cleaning solution supplying unit to supply the cleaning solution to the nozzle, the cleaning solution supplying unit including a vibration generating member to generate vibrations to atomize the cleaning solution.

According to an aspect of the present invention, the cleaning solution supplying unit may be disposed in the cleaning solution tank, and may be disposed to not contact the nozzle.

According to an aspect of the present invention, the vibration generating member may be disposed at an upper portion of the cleaning solution tank, the vibration generating member having a space formed in a center thereof; and the cleaning solution supplying unit may include a cleaning solution supplying member to supply the cleaning solution from the cleaning solution tank to the space of the vibration generating member, wherein, when the vibration generating member operates, the cleaning solution in the space of the vibration generating member is atomized and moved to the nozzle.

According to an aspect of the present invention, the vibration generating member may comprise a ring type piezoelectric transducer.

According to an aspect of the present invention, the cleaning solution supplying unit may be a posours foam member having a diameter corresponding to an inner diameter of the ring type piezoelectric transducer, the porous foam member having a first end in contact with the inner diameter of the ring type piezoelectric transducer, and a second end in contact with the cleaning solution.

According to an aspect of the present invention, a mesh member may be disposed at the first end of the porous foam member.

According to an aspect of the present invention, the nozzle wetting apparatus may include: a shuttle carrier in which both the cleaning solution tank and the cleaning solution supplying unit are disposed, the shuttle carrier to carry the cleaning solution supplying unit to face the nozzle during a nozzle wetting operation.

According to an aspect of the present invention, the cleaning solution tank may be detachably disposed in the shuttle carrier.

According to an aspect of the present invention, the shuttle carrier may include a power unit to supply the vibration generating member with electric power.

According to an aspect of the present invention, the power unit may include a battery.

According to an aspect of the present invention, the nozzles may be arranged to spray ink downward, and the vibration generating member may be disposed at an upper portion of the cleaning solution tank.

According to an aspect of the present invention, the nozzle may include a plurality of nozzles disposed in a direction transverse to a printing medium transferring direction.

According to an aspect of the present invention, the shuttle carrier may reciprocate at a speed of about 0.4-0.6 inch/sec.

According to another aspect of the present invention, an inkjet image forming apparatus may include; a printing medium loading unit; a printing medium transferring unit to transfer a printing medium loaded in the printing medium loading unit; an imaging unit having a plurality of nozzles that is arranged in a direction transverse to a printing medium transferring direction and to form images on the printing medium transferred by the printing medium transferring unit; and a nozzle wetting apparatus to wet the nozzles to remove a nozzle clog. According to an aspect of the present invention, the nozzle wetting apparatus may include a cleaning solution tank to store cleaning solution for cleaning the nozzles and a cleaning solution supplying unit to supply the cleaning solution to the nozzles and comprising a vibration generating member; the vibration generating member to generate vibrations to atomize the cleaning solution; and.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view of a portion of the conventional contact type nozzle cleaning apparatus;

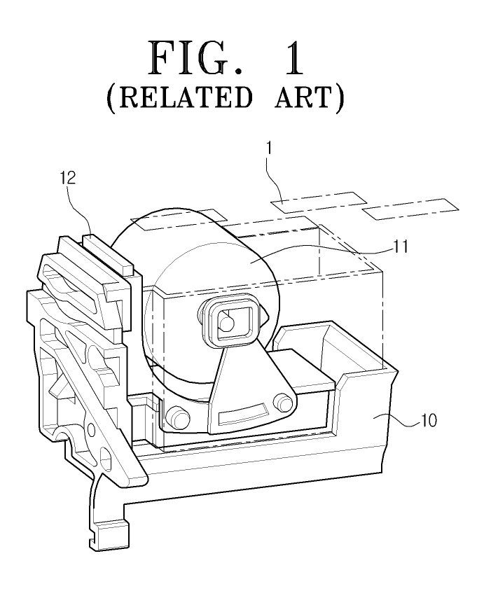

FIG. 2 is a perspective view of an inkjet image forming apparatus having a nozzle wetting apparatus according to an embodiment of the present invention;

FIG. 3 is an enlarged perspective view of the nozzle wetting apparatus of FIG. 2;

FIG. 4 is a sectional view schematically illustrating the nozzle wetting apparatus of FIG. 3; and

FIG. 5 is a perspective view of a main cleaning blade for cleaning a nozzle on which a nozzle clog is dissolved by a nozzle wetting apparatus according to an embodiment of the present invention.

Throughout the drawings, like reference numerals will be understood to refer to like parts, components and structures.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures. The matters defined in the description, such as a detailed construction and elements thereof, are provided to assist in a comprehensive understanding of the invention. Thus, it is apparent that aspects of the present invention may be carried out without those defined matters. Also, well-known functions or constructions are omitted to provide a clear and concise description of exemplary embodiments of the present invention.

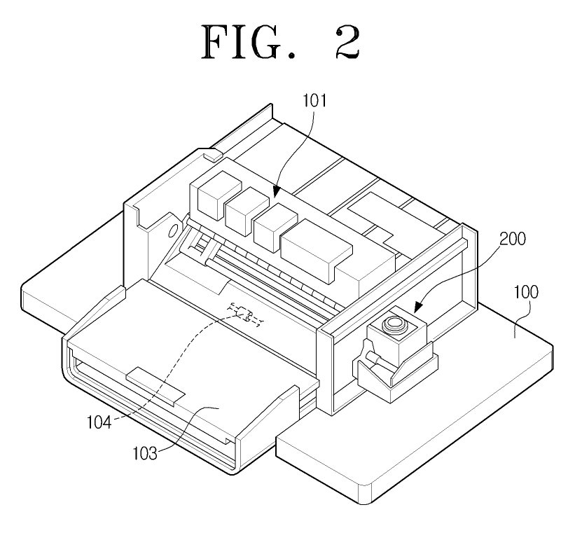

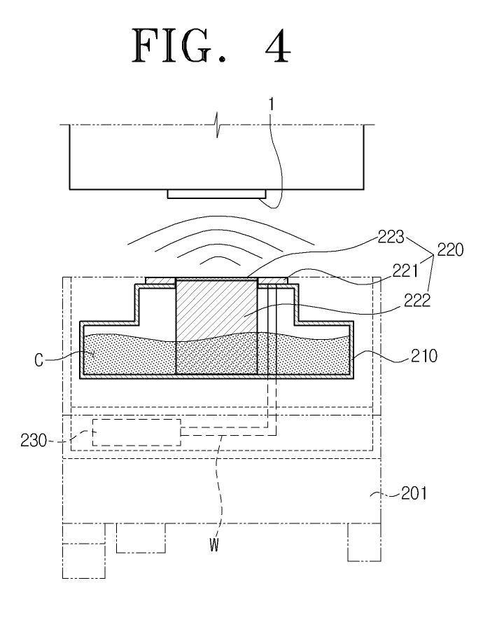

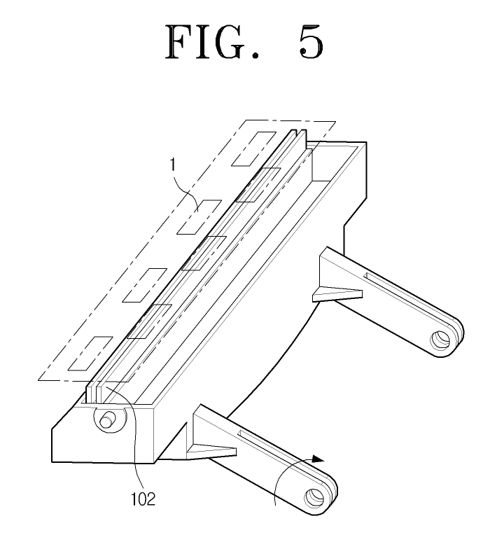

FIG. 2 is a perspective view illustrating an inkjet image forming apparatus having a nozzle wetting apparatus according to an embodiment of the present invention. Referring to FIG. 2, the array type inkjet image forming apparatus according to an embodiment of the present invention may include a mainframe 100, an array head assembly 101 that is disposed on the mainframe 100 and has a plurality of nozzles 1 (see FIGS. 4 and 5), and a nozzle wetting apparatus 200 configured to dissolve a nozzle clog generated in the array head assembly 101 according to selection of a user or a detecting signal from a detecting unit (not illustrated). The nozzles 1 may be arranged to project ink downward. The array type inkjet image forming apparatus further includes a printing medium transferring unit 104 to cause a printing medium being loaded in a printing medium loading unit 103 to be transferred, and forms ink images on the transferred printing medium.

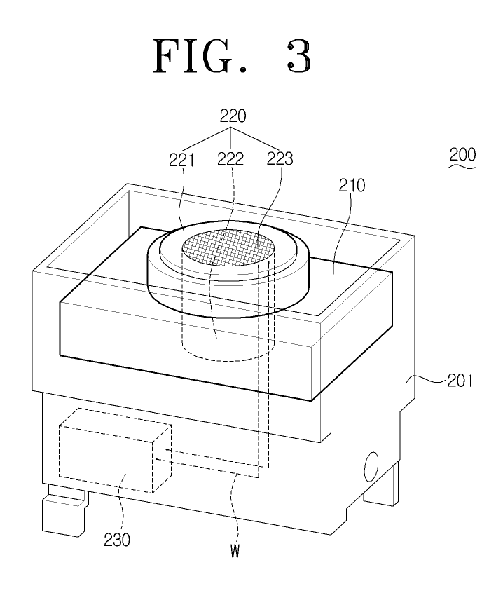

The nozzle wetting apparatus 200, as illustrated in FIG. 3, may include a cleaning solution tank 210, a cleaning solution supplying unit 220, a power unit 230, and a shuttle carrier 201 in which the cleaning solution tank 210, the cleaning solution supplying unit 220, and the power unit 230 are disposed.

The shuttle carrier 201 is configured to reciprocate along a moving pathway that is formed below and spaced apart from the array head assembly 101 shown in FIG. 2. A space in which the shuttle carrier 201 can move is formed below the array head assembly 101. The shuttle carrier 201 may reciprocate at a speed range of 0.4-0.6 inch/sec in a direction transverse to a printing medium transferring direction (hereinafter, referred to as a printing medium width direction) during a wetting operation of the nozzle 1. The nozzle wetting operation performed by the shuttle carrier 201 will be explained in detail later.

The cleaning solution tank 210, as illustrated in FIG. 3, is configured to store a quantity of cleaning solution C (see FIG. 4) that can dissolve ink and contaminants solidified on the nozzle 1, and is detachably disposed in the shuttle carrier 201. An opening is formed at an upper portion of the cleaning solution tank 210. The cleaning solution supplying unit 220 is disposed in the opening. The cleaning solution tank 210 and the cleaning solution supplying unit 220 may be formed in a single module so that when the cleaning solution being stored in the cleaning solution tank 210 is depleted, the cleaning solution tank 210 and the cleaning solution supplying unit 220 can be replaced as one.

The cleaning solution supplying unit 220 generates vibrations to atomize the cleaning solution as a mist of fine droplets and the atomized cleaning solution to move the nozzle 1. The cleaning solution supplying unit 220 may include a vibration generating member 221 having a space formed in a center thereof, and a cleaning solution supplying member 222 to supply the cleaning solution to the center space surrounded by the vibration generating member 221.

Various apparatuses may be used as the vibration generating member 221 as long as the vibration generating member 221 can generate vibration to atomize the cleaning solution as a mist of fine droplets. Also, the vibration generating member 221 may be formed in various shapes as long as the vibration generating member 221 has a space in which the cleaning solution may flow through the center thereof. The vibration generating member 221 may be formed in a hollow quadrangle (that is a quadrangle with a hole extending therethrough), a hollow polygon (that is a polygon with a hole extending therethrough), or a hollow circle (a ring shape, that is a circle with a hole extending therethrough). In this embodiment, a ring type piezoelectric transducer may be used as the vibration generating member 221 as illustrated in FIG. 3.

The ring type piezoelectric transducer 221 can be formed in various sizes according to the size of the nozzle. In this embodiment, the ring type piezoelectric transducer 221 has an inner diameter of approximately 20 mm, a width of approximately 5 mm (thereby making the total diameter approximately 30 mm), and a height of approximately 4 mm, and is formed to operate at an operation frequency of approximately 0.1 MHz by a direct current driving voltage of approximately 3 V. When the shuttle carrier 201 having the piezoelectric transducer 221 configured as described above moves at a speed range of 0.4-0.6 inch/sec, approximately 0.4 cc (cubic centimeter) of the cleaning solution atomized as mist may be transferred to the nozzle 1. The size, the operation frequency, and the driving voltage of the piezoelectric transducer 221 can be changed according to the size of the nozzle 1 of the inkjet image forming apparatus. However, the piezoelectric transducer 221 may be configured so that the driving voltage and operation frequency thereof are substantially maintained at the value as described above.

The cleaning solution supplying member 222 may have any form as long as the cleaning solution supplying member 222 can supply the cleaning solution contained in the cleaning solution tank 210 to the space in the center of the vibration generating member 221. When the vibration generating member 221 is a ring type piezoelectric transducer 221, the cleaning solution supplying member 222 supplies the cleaning solution to an inner space of the ring type piezoelectric transducer 221. In this embodiment, a porous foam member is used as the cleaning solution supplying member 222. The porous foam member 222 may include a sponge, etc.

A first end of the porous foam member 222 (hereinafter, referred to as an exposing end) is disposed in the inner space of the ring type piezoelectric transducer 221 and contacts a surface of the inner space of the piezoelectric transducer 221. The first end of the porous foam member 222 is surrounded by the ring type piezoelectric transducer such that an end surface of the first end of the porous foam member 222 is exposed toward the nozzle 1. Also, as illustrated in FIG. 4, a second end of the porous foam member 222 is submerged in the cleaning solution contained in the cleaning solution tank 210. Therefore, the cleaning solution is absorbed into the porous foam member 222 via the submerged portion of the porous foam member 222, i.e., the submerged second end of the porous foam member 222. The absorbed cleaning solution is changed into mist at the exposing end by the vibration generated by the ring type piezoelectric transducer 221 and wets the surface of the nozzle 1. The nozzle wetting apparatus 200 moves along the moving pathway to wet multiple nozzles 1. At this time, the cleaning solution supplying unit 220 may be configured so that approximately 4 cc of the cleaning solution is transferred to each of the nozzles 1. Also, a mesh member 223 may be disposed at the exposing end of the porous foam member 222 to prevent the exposing end from being contaminated by dust, etc.

The power unit 230 supplies the cleaning solution supplying unit 220 with electric power and may include a control board to control the piezoelectric transducer 221 and a battery to supply DC (direct current) electric power to the control board and the piezoelectric transducer 221. The battery may supply approximately 3V of electric power. However, the supplying voltage of the battery can be changed as desired. The power unit 230 may be configured to connect with the cleaning solution supplying unit 220 using wiring W. The cleaning solution tank 210, the cleaning solution supplying unit 220, and the power unit 230 are disposed in or on the shuttle carrier 201 so that the wiring W can be fixed to the shuttle carrier 201.

Hereinafter, operation of the nozzle wetting apparatus 200 of the array type inkjet image forming apparatus according to an embodiment of the present invention will be explained. The array type inkjet image forming apparatus may include the array head assembly 101 on which the plurality of nozzles 1 is fixed as an imaging unit. When starting a printing operation, the array type inkjet image forming apparatus uses a printing medium transferring unit 104 to load a printing medium in a printing medium loading unit 103 to be transferred through the image forming apparatus and forms ink images on the transferred printing medium.

The nozzles 1 of the array head assembly 101 have been covered tightly by a capping module (not illustrated) in a standby mode. When starting the printing operation, the capping module, having covered up the array head assembly 101, moves so as to expose the nozzles 1.

After the nozzles 1 are exposed, a control portion of the image forming apparatus performs a spitting process in which a little quantity of ink is fired through the nozzles 1 and controls the main cleaning blade 102 (see FIG. 5) to physically contact and wipe the nozzles 1. After a print preparing process as described above finishes, a platen (not illustrated) may rise and/or rotate to locate at a position adjacent to and below the nozzles 1 so as to face the nozzle 1. The printing medium is transferred through a space between the nozzles 1 and the platen. The nozzles 1 fire ink to form images on a side of the transferred printing medium facing the nozzles 1.

After the printing operation finishes, the array head assembly 101 may be capped in a reverse order of the procedure as described above. That is, the platen may move and/or rotate to be separated from the nozzles 1, and then the main cleaning blade 102 may physically wipe the nozzles 1. After that, the capping module moves to cover up the nozzles 1, thereby preventing the nozzles 1 from being exposed to air.

When a detecting sensor (not illustrated) detects a nozzle clog or when a user who is dissatisfied with a printing quality selects, a nozzle clog removing mode may be started. The nozzle wetting apparatus 200 supplies the cleaning solution to the surfaces of the nozzles 1 to cause the surfaces of the nozzles 1 to be wet to remove the nozzle clog blocking flow of the ink through the nozzles 1. The nozzle wetting apparatus 200 may reciprocate below the nozzles 1 to allow the cleaning solution, atomized like mist, to be supplied to the surface of the nozzles 1.

In the nozzle clog removing mode, the capping module that caps the array head assembly 101 and the platen adjacent to the array head assembly 101 separate from the array head assembly 101 and form a space through which the shuttle carrier 201 can move below the array head assembly 101. FIG. 2 is a perspective view illustrating the inkjet image forming apparatus in which the platen and the capping module move down to form the space in which the shuttle carrier 201 can move below the array head assembly 101.

After the space is formed below the array head assembly 101, the shuttle carrier 201 reciprocates along the moving pathway through the space below the array head assembly 101 while not contacting the array head assembly 101. The cleaning solution supplying unit 220 mounted on the shuttle carrier 201 supplies the atomized cleaning solution to the nozzles 1 to wet the surfaces of the nozzles 1.

In other words, when the shuttle carrier 201 starts to move, the cleaning solution supplying unit 220 receives DC electric power from the power unit 230 so that the ring type piezoelectric transducer 221 starts to vibrate. When the piezoelectric transducer 221 vibrates, the cleaning solution C is absorbed and moves near the exposing end of the porous foam member 222, which is located in the inner space of the piezoelectric transducer 221 as illustrated in FIG. 4 and is vaporized or atomized by the vibration of the piezoelectric transducer 221. The atomized cleaning solution moves to the nozzles 1 in the form of mist so as to wet the surface of the nozzles 1.

When the cleaning solution C is vaporized or atomized from the end of the porous foam member 222 that faces the nozzles 1, that is, the exposing end. Further, the cleaning solution C inside the cleaning solution tank 210 is continuously absorbed into the porous foam member 222 and moved to the exposing end by osmotic action. The mesh member 223 is disposed to cover the exposing end according to some aspects of the present invention but is not necessary in all aspects. The osmotic action may occur at all portions of the porous foam member 222 exposed to the cleaning solution C or may be limited to specific portions of the porous foam member 222.

As described before, the size, driving voltage, and operation frequency of the ring type piezoelectric transducer 221 can be changed according to the size, shape, and number of the nozzles 1. However, when using a battery as the power unit 230, the piezoelectric transducer 221 may be configured so that the driving voltage is approximately 3V DC and the operation frequency is approximately 0.1 MHz. When the shuttle carrier 201 with the ring type piezoelectric transducer 221 configured as described above moves at an appropriate speed, a proper quantity of the atomized cleaning solution sufficiently wets the surface of each of the nozzles 1 without excessively wetting the surface of each of the nozzles 1. For example, approximately 4 cc of the cleaning solution may be transferred to each of the nozzles 1. Here, the excessive wetting is referred to as a state in that the cleaning solution and/or ink remaining on the surface of the nozzle 1 flows down from or drips from the surface of the nozzle 1.

The power unit 230 that supplies the cleaning solution supplying unit 220 with the electric power may be disposed in the main body of the image forming apparatus. Alternatively, the power unit 230 may be configured to use the electric power of the image forming apparatus and not the battery. However, this power unit 230 may require longer wiring W as compared with the power unit 230 using the battery. Accordingly, it is preferred that the power unit 230 is disposed in the shuttle carrier 201 together with the cleaning solution supplying unit 220.

When performing the nozzle clog removing operation, the surface of the nozzle 1 is wetted by the supply of the cleaning solution so that remaining ink and/or contaminants solidified on the surface of the nozzle 1 are dissolved and softened by the cleaning solution. As a result, the main cleaning blade 102 can wipe the nozzles 1 to remove the ink and contaminants dissolved by the cleaning solution. Therefore, the nozzle clog may be removed. After that, the capping module moves to cover the nozzles 1, thereby preventing the nozzles 1 from being exposed to air.

The nozzle clog removing operation may be performed before the printing operation, after the printing operation, or when the image forming apparatus is in a standby mode. If the nozzle clog removing mode is performed before the printing operation, a first page print time (FPPT) may be lengthened. In such case, users sensitive to FPPT may complain about the image forming apparatus.

With the nozzle wetting apparatus according to an embodiment of the present invention, the nozzle wetting apparatus does not contact the surface of the nozzles of the array head assembly so that the wetting operation does not contaminate the nozzles.

Also, with the nozzle wetting apparatus according to an embodiment of the present invention, because the cleaning solution tank may be disposed in the shuttle carrier integrally with the cleaning solution supplying unit, the structure thereof is simple and the manufacturing cost thereof is cheap compared to the structure in which the cleaning solution tank is disposed outside the shuttle carrier.

Also, with the nozzle wetting apparatus according to an embodiment of the present invention, because the power unit that supplies electric power to the cleaning solution supplying unit can be disposed in the shuttle carrier, the inner structure thereof can be formed simply.

Also, with the nozzle wetting apparatus according to an embodiment of the present invention, the cleaning solution is absorbed in the porous foam member so that the cleaning solution rarely leaks out.

With the nozzle wetting apparatus according to an embodiment of the present invention, because the nozzle wetting apparatus can sufficiently wet the nozzles in which a nozzle clog occurs while not contacting the nozzles, secondary contamination can be prevented from occurring during a nozzle wetting process, and ink mixing can be prevented from occurring in the nozzle by the cleaning solution being excessively sprayed.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A nozzle wetting apparatus for an inkjet image forming apparatus, the nozzle wetting apparatus comprising:
a cleaning solution tank to store cleaning solution for cleaning a nozzle; and
a cleaning solution supplying unit to supply the cleaning solution to the nozzle, the cleaning solution supplying unit comprising:
a vibration generating member to generate vibrations to atomize the cleaning solution.

2. The nozzle wetting apparatus of claim 1, wherein the cleaning solution supplying unit is disposed in the cleaning solution tank.

3. The nozzle wetting apparatus of claim 1, wherein the cleaning solution supplying unit does not contact the nozzle.

4. The nozzle wetting apparatus of claim 1, wherein the vibration generating member is disposed at an upper portion of the cleaning solution tank, the vibration generating member having a space formed in a center thereof; and
the cleaning solution supplying unit comprises a cleaning solution supplying member to supply the cleaning solution from the cleaning solution tank to the space of the vibration generating member,
wherein, when the vibration generating member operates, the cleaning solution in the space of the vibration generating member is atomized and moved to the nozzle.

5. The nozzle wetting apparatus of claim 4, wherein the vibration generating member comprises a ring type piezoelectric transducer.

6. The nozzle wetting apparatus of claim 5, wherein the cleaning solution supplying member is a porous foam member having a diameter corresponding to an inner diameter of the ring type piezoelectric transducer, the porous foam member having a first end in contact with the inner diameter of the ring type piezoelectric transducer, and a second end in contact with the cleaning solution.

7. The nozzle wetting apparatus of claim 6, wherein the cleaning solution supplying unit further comprises:
a mesh member disposed at the first end of the porous foam member.

8. The nozzle wetting apparatus of claim 1, further comprising:
a shuttle carrier in which both the cleaning solution tank and the cleaning solution supplying unit are disposed, the shuttle carrier to carry the cleaning solution supplying unit to face the nozzle during a nozzle wetting operation.

9. The nozzle wetting apparatus of claim 8, wherein the cleaning solution tank is detachably disposed in the shuttle carrier.

10. The nozzle wetting apparatus of claim 9, wherein the nozzles are arranged to spray ink downward, and the vibration generating member is disposed at an upper portion of the cleaning solution tank.

11. The nozzle wetting apparatus of claim 10, wherein the nozzle comprises a plurality of nozzles disposed in a direction transverse to a printing medium transferring direction.

12. The nozzle wetting apparatus of claim 8, wherein the shuttle carrier reciprocates in a direction transverse to a printing medium transferring direction when cleaning the nozzle.

13. The nozzle wetting apparatus of claim 12, wherein the shuttle carrier reciprocates at a speed of about 0.4-0.6 inch/sec.

14. The nozzle wetting apparatus of claim 8, wherein the shuttle carrier comprises a power unit to supply the vibration generating member with electric power.

15. The nozzle wetting apparatus of claim 14, wherein the power unit comprises a battery.

16. An inkjet image forming apparatus, comprising:
a printing medium loading unit;
a printing medium transferring unit to transfer a printing medium loaded in the printing medium loading unit;
an imaging unit having a plurality of nozzles that is arranged in a direction transverse to a printing medium transferring direction and to form images on the printing medium transferred by the printing medium transferring unit; and
a nozzle wetting apparatus to wet the nozzles to remove a nozzle clog, the nozzle wetting apparatus comprising:
a cleaning solution tank to store cleaning solution for cleaning the nozzles;
a cleaning solution supplying unit to supply the cleaning solution to the nozzle, the cleaning solution supplying unit comprising:
a vibration generating member to generate vibrations to atomize the cleaning solution.

17. The inkjet image forming apparatus of claim 16, further comprising:
a blade to remove ink and/or debris from the nozzles on which the cleaning solution has been applied.

18. An inkjet image forming apparatus, comprising:
nozzles disposed to deliver ink to a printing medium; and
a nozzle wetting apparatus disposed to atomize a cleaning solution upon the nozzles to clean the nozzles.

19. The inkjet image forming apparatus of claim 18, wherein the nozzle wetting apparatus reciprocates beneath the nozzles.

20. The inkjet image forming apparatus of claim 18, wherein the nozzle wetting apparatus comprises a piezoelectric transducer to atomize the cleaning solution.

21. The inkjet image forming apparatus of claim 20, wherein the piezoelectric transducer has a hollow shape, and the nozzle wetting apparatus further comprises a cleaning solution supplying member disposed in the hollow shape of the piezoelectric transducer.

22. The inkjet image forming apparatus of claim 21, wherein the cleaning solution supplying member supplies cleaning solution to the piezoelectric transducer via osmosis.

23. The inkjet image forming apparatus of claim 18, wherein the nozzle wetting apparatus comprises:
a polygonal, circular, or elliptical piezoelectric transducer to atomize the cleaning solution.
